(19) United States
(12) Patent Application Publication
(10) Pub. No.: US 2012/0147306 A1
(43) Pub. Date: Jun. 14, 2012

(54) LIQUID CRYSTAL DISPLAY DEVICE

(75) Inventors: Yoshimizu Moriya, Osaka (JP); Yasuyoshi Kaise, Osaka (JP); Noritaka Ajari, Osaka (JP)

(73) Assignee: SHARP KABUSHIKI KAISHA, Osaka (JP)

(21) Appl. No.: 13/392,000

(22) PCT Filed: Jun. 4, 2010
(86) PCT No.: PCT/JP2010/059532

§ 371 Date: Feb. 23, 2012

(30) Foreign Application Priority Data
Sep. 7, 2009 (JP) 2009-206177

(51) Int. Cl. G02F 1/1335

(52) U.S. Cl. 349/113

(57) ABSTRACT

Disclosed in the present invention is a transflective liquid crystal display device that has high light transmittance and reflectance, an excellent visibility, and suitable display characteristics achieved by the sufficiently controlled liquid crystal orientation. A liquid crystal display device according to the present invention includes a thin-film transistor array substrate, an opposite substrate, and a liquid crystal layer sandwiched therebetween. The liquid crystal display device includes a pixel having a reflective display region that performs a reflective display, and a transmissive display region that performs a transmissive display. When the substrate surface is viewed from the normal direction, the transmissive display region is disposed in a center section of the pixel. In the thin-film transistor array substrate, an insulating film is formed on a primary surface of a supporting substrate on a side facing the liquid crystal layer, and columnar spacers protruding toward the liquid crystal layer side are disposed at corners of the respective pixels. The insulating film has a recess formed in the transmissive display region. The opposite substrate has a common electrode on the primary surface thereof on a side facing the liquid crystal layer.

### TECHNICAL FIELD

The present invention relates to a liquid crystal display device, and more particularly, to a transflective liquid crystal display device having a columnar spacer.

### BACKGROUND ART

Liquid crystal display devices are widely used for electronic devices such as monitors, projectors, mobile phones, personal digital assistants (PDAs) by virtue of its desirable features such as thin profile, light-weight, and low power consumption. In particular, for medium and small-sized electronic devices that mainly include mobile phones, gaming devices, and automotive instrumentation, liquid crystal display devices called transflective liquid crystal display devices (display devices that perform both reflective and transmissive displays) are used.

A transflective liquid crystal display device has a transmissive display region and a reflective display region. In dim environments such as indoors, the transmissive display region performs the transmissive display by guiding light from a rear surface side, such as light from a backlight that is disposed in the liquid crystal display panel, into the liquid crystal display panel, and emitting the light to the outside for displaying an image. In bright environments such as outdoors, the reflective display region performs the reflective display by guiding light from a front surface side (viewer's side) such as light from a front light or ambient light into the liquid crystal display panel, and reflecting and emitting this light to the outside for displaying an image. This allows the transflective liquid crystal display device to have an excellent visibility in both bright and dark environments.

In recent years, with the increasing use of devices that are used in not only indoor environments, but also outdoor environments such as mobile phones, improvement in visibility, and more particularly, an excellent visibility in outdoor environments have been demanded. In response to the demand, a liquid crystal display device that incorporated the vertical alignment (VA) mode as a liquid crystal alignment mode in a transflective liquid crystal display device has been proposed (see Patent Document 1, for example). Because the VA mode liquid crystal display device is capable of a very high contrast ratio, the visibility can be improved.

In addition to the above-mentioned configuration, the liquid crystal display device described in Patent Document 1 is further configured with a multi-gap structure where an insulating film formed in the first substrate has different thicknesses between the transmissive display region and the reflective display region. Also, in the transmissive display region, the second substrate is provided with alignment control structures for controlling the orientation of liquid crystals so that the liquid crystal orientation and the electric fields can be regulated. These configurations are provided for the better display characteristics. As the alignment control structures, in addition to the protrusions described in Patent Document 1, other configurations such as forming slits in a common electrode that applies a voltage to liquid crystals are also known.

In the transflective liquid crystal display device employing the vertical alignment mode, a multi-domain structure and a single-domain structure are known as techniques that use alignment control structures for improving display characteristics. In the multi-domain structure, images are displayed by pixels that are respectively divided into a plurality of domains by the alignment control structures. In the single domain structure, the same alignment control structure is commonly used by transmissive display region and the reflective display region, and therefore, the domain division is eliminated.

### RELATED ART DOCUMENTS

### Patent Documents

Patent Document 1: Japanese Patent Application Laid-Open Publication No. 2005-148401

### SUMMARY OF THE INVENTION

### Problems to be Solved by the Invention

In order to improve the visibility of the transflective liquid crystal display device employing the vertical alignment mode, it is necessary to increase the light transmittance of the transmissive display region and the light reflectance of the reflective display region. Also, in the liquid crystal display device in which pixels are miniaturized to reduce the device size, the high light reflectance is particularly required.

In the liquid crystal display device having the above-mentioned multi-domain structure, the suitable orientation state of the liquid crystals can be ensured by the alignment control structures, and therefore, the stable liquid crystal orientation and the shorter response time are achieved. However, because the alignment control structures or slit regions disposed between the respective domains for the domain division are formed in the transmissive display region and/or the reflective display region, the aperture ratio of the pixel becomes lower, and as a result, the light transmittance and/or the light reflectance tend to be reduced.

On the other hand, in a liquid crystal display device with the single-domain structure, because the alignment control structures or the slit regions are reduced, the aperture ratio of the pixel can be increased, and therefore, the light transmittance and/or reflectance can be improved. However, because the alignment control force for liquid crystals is reduced, the display characteristics tend to be degraded. When a liquid crystal display device requires high light reflectance due to the miniaturization of pixels as described above, the reflective display region is enlarged to improve the light reflectance, but this may cause the viewing angle characteristics of the transmissive display region to be lowered, or the larger domain may cause the deterioration in the liquid crystal orientation stability or the response time.

As described above, the transflective liquid crystal display device having high light transmittance in the transmissive display region, high light reflectance in the reflective display region, and the excellent display characteristics is demanded.

In addition to the above-mentioned domain division technique, the multi-gap structure is also known as a technique to achieve the better visibility in the transflective liquid crystal display device as described in Patent Document 1. The multi-gap structure controls a cell gap by making the thickness of an insulating film in the transmissive display region and in the reflective display region differ from each other. However, with the multi-gap structure alone, the liquid crystal orientation may not be sufficiently controlled in a slope region between a region with a thicker cell gap and a region with a thinner cell gap. Even when protrusions or slits are further provided as the alignment control structures for the liquid crystals, there still has been a room for improvement to achieve the sufficiently stable orientation state of the liquid crystals while ensuring the high light transmittance and reflectance.

The present invention was made in view of the above-mentioned situation, and is aiming at providing a transflective liquid crystal display device having high light transmittance and reflectance, excellent visibility, and the sufficiently controlled liquid crystal orientation that therefore provides suitable display characteristics.

### Means for Solving the Problems

In the quest for a transflective liquid crystal display device that can provide high light transmittance and reflectance, the inventors of the present invention focused on the alignment control structures that control the liquid crystal orientation and the slit regions disposed for the domain division as an impediment to the improvement of the aperture ratio of the pixel. The inventors found that by eliminating the alignment control structures and the slit regions, by disposing a columnar spacer in a pixel at a corner thereof that does not contribute to the display, and by utilizing the columnar spacer to control the liquid crystal orientation, the aperture ratio of the pixel can be increased, and the high light transmittance and reflectance can be achieved, resulting in the improvement in the display characteristics and the response time of the liquid crystals. The inventors also found that by employing a multi-gap structure in which a recess is formed in an insulating film disposed on the thin film transistor array substrate side to adjust the thickness of the liquid crystal layer, a liquid crystal display device with suitable display characteristics having excellent viewing angle characteristics and the like can be obtained. As a result, the above-mentioned problems have been admirably solved, leading to the completion of the present invention.

That is, provided according to the present invention is a liquid crystal display device including:

a liquid crystal layer sandwiched between a thin film transistor array substrate and an opposite substrate; and

a plurality of pixels respectively having a reflective display region that performs a reflective display and a transmissive display region that performs a transmissive display,

wherein the transmissive display region is disposed in a center section of the pixel when a substrate surface is viewed from a normal direction,

wherein the thin film transistor array substrate has an insulating film disposed on a primary surface of a supporting substrate on a side facing the liquid crystal layer, and a columnar spacer protruding toward the liquid crystal layer side at a corner of each pixel, the insulating film having a recess formed in the transmissive display region so as to increase a thickness of the liquid crystal layer when viewed from a normal direction to the substrate surface, and

wherein the opposite substrate has a common electrode on a primary surface thereof on a side facing the liquid crystal layer.

The liquid crystal display device according to the present invention performs a display by changing a voltage applied to the liquid crystal layer and therefore by changing the retardation of the liquid crystal layer. Specifically, by controlling the strength of the electric fields applied between pixel electrodes of respective pixel regions formed on the thin film transistor array substrate side and a common electrode formed on the opposite substrate side, the orientation state of the liquid crystals in the respective pixel regions is changed. This causes the light transmittance to change, thereby displaying an image.

In each pixel, the transmissive display region refers to a region that contributes to the transmissive display, and the reflective display region refers to a region that contributes to the reflective display. That is, light used for the transmissive display passes through the liquid crystal layer in the transmissive display region, and light used for the reflective display passes through the liquid crystal layer in the reflective display region.

In each pixel, the transmissive display region is disposed in the center section of the pixel, and the reflective display regions are disposed on both sides of the transmissive display region. There is no special limitation on the ratio between the transmissive display region and the reflective display region. However, when the pixels are miniaturized, and therefore, high light reflectance is required, it is preferable that the ratio of the reflective display region become larger.

In the above-mentioned thin film transistor array substrate, the insulating film formed on the primary surface of the supporting substrate on the side facing the liquid crystal layer is a resin film that has an SHA (Super High Aperture) structure, for example. The liquid crystal display panel having the SHA structure can achieve the higher aperture ratio and a bright display by forming an insulating film made of a special resin on wiring lines that are disposed on the thin film transistor array substrate, and by disposing pixel electrodes on this insulating film.

In the transflective liquid crystal display device, in the transmissive display region, light from the rear surface side passes through the liquid crystal layer only once when the light enters the liquid crystal display panel and exits it. On the other hand, in the reflective display region, light from the front surface side passes through the liquid crystal layer twice when the light enters the liquid crystal display panel and exits it. This creates the optical path difference between the light passing through the transmissive display region and the light passing through the reflective display region. In order to eliminate the optical path difference, it is necessary to make the optical path length in the transmissive display region coincide with the optical path length in the reflective display region. Thus, in the above-mentioned insulating film, a recess is formed so as to increase the thickness of the liquid crystal layer in the transmissive display region when viewed from the normal direction to the substrate surface.

A method of forming the recess includes the following: first, forming a first resin film as the insulating film, and then forming a second resin film on the first resin film in the reflective display region using a photomask or the like so that a protrusion is formed in the reflective display region. In this way, a recess for increasing the thickness of the liquid crystal layer is formed in the transmissive display region when the substrate surface is viewed from the normal direction. When the insulating film is formed on the primary surface of the supporting substrate, and is patterned into a desired shape by an exposure process, the above-mentioned recess may also be formed in the transmissive display region simultaneously during this exposure process. There is no special limitation on the exposure method, but the recess can be formed with ease by employing a method that uses a photomask provided with prescribed slit patterns to reduce the film thickness of prescribed portions of a resist pattern film, such as the half-tone exposure, the gray-tone exposure, the double exposure, or the like. The recess can also be formed by etching the insulating film.

The thickness of the liquid crystal layer in the reflective display region (also referred to as “cell thickness” hereinafter) is preferably about half of the cell thickness in the transmissive display region. Although it is more preferable that the thickness be exactly half, it may also be about half as long as the optical path length of light passing through the liquid crystal layer of the reflective display region and the optical path length of light passing through the liquid crystal layer of the transmissive display region become close enough to have no substantial effect on the display quality. Specifically, it is preferable that the thickness of the liquid crystal layer of the reflective display region be 30% to 70% of the thickness of the liquid crystal layer of the transmissive display region.

The columnar spacer protruding toward the liquid crystal layer side at the corner of each pixel controls the liquid crystal orientation. The columnar spacer is preferably a resin structure so that it can be manufactured with ease. Such a resin structure can be formed of a photosensitive resin such as an acrylic resin by an exposure technique such as photolithography, for example.

In the present invention, as described above, by employing the single-domain structure with the columnar spacer disposed at the corner of the pixel, the aperture ratio of the pixel can be increased, and the high light transmittance and the high light reflectance can be achieved in the transmissive display region and in the reflective display region, respectively. This results in the improvement in visibility. Also, by configuring the transmissive display region and the reflective display region in each pixel such that the transmissive display region is disposed in the center and the reflective display regions are disposed on both sides of the transmissive display region, the area of the reflective display region can be increased, and the higher light reflectance can therefore be achieved. This allows for the miniaturization of pixels.

In addition to such an arrangement of the display regions, by employing a multi-gap structure using an insulating film formed in the thin film transistor array substrate, the liquid crystals are oriented so as to tilt toward the transmissive region disposed in the center of the pixel from the reflective regions disposed on the outer sides of the pixel. Further, by employing the single-domain structure with the columnar spacer disposed in a corner of the pixel, the alignment control force acting on the orientation in the direction from the outer sides of the pixel toward the center is generated by the columnar spacer. As described, by making the liquid crystal alignment vector from the columnar spacer and the alignment vector from the end portions of the pixel electrode aligned along one direction, the stronger alignment control force for the liquid crystals in all directions of the pixel can be provided. This makes it possible to ensure the stable liquid crystal orientation, to achieve the wider viewing angle characteristics, and to suppress the decline in the respond time, and as a result, the transflective liquid crystal display device having excellent display characteristics can be provided.

As a configuration of the liquid crystal display device, as long as these constituting elements are included as primary components, the present invention is not particularly limited by other constituting elements.

In the present invention, the liquid crystal display device may be provided with a main spacer that makes contact with the opposite substrate and a sub spacer that makes no contact with the opposite substrate. The columnar spacer may include both the main spacer and the sub spacer.

The main spacer is formed in a prescribed thickness so as to make contact with the opposite substrate, and therefore can maintain the cell gap between the thin film transistor array substrate and the opposite substrate. It can also reduce damages to the liquid crystal display device and the like by absorbing a pressure load applied from the outside. The sub spacer may have a function of absorbing a pressure load applied from the outside, and may be formed so as to be slightly thinner than the thickness of the columnar spacer so that it makes no contact with the opposite substrate unless the gap between the substrates becomes narrower because of the application of the pressure load from the outside.

Here, the term “making contact” used here means not only the entire end surface of the main spacer being in contact with the opposite substrate, but also a part of the end surface being in contact with the opposite substrate. That is, the opposite substrate in a region facing the main spacer may not necessarily have a flat surface profile, and the insulating film formed on the surface thereof may have an uneven surface profile, for example. There is no special limitation on the configuration of contact between the main spacer and the insulating film as long as the cell gap can be maintained.

There is no special limitation on shapes of the main spacer and the sub spacer as long as they have a columnar shape. The columnar shape includes a circular column, a rectangular column, a cone, a pyramid, and the like. There is no special limitation on diameters of the main spacer and the sub spacer either, and they can be suitably set so as to meet recognized purposes of the main spacer, required load capacities, and the like. Further, the sub spacer may have the same shape and the same diameter as those of the main spacer, or it may have a different shape and a different diameter. Examples of the main spacer and the sub spacer include: the main spacer being a square column measuring 12 μm by 12 μm and the sub spacer being a circular column of 12 μm in diameter; the main spacer being a square columnar measuring 9 μm by 9 μm and the sub spacer being a rectangular column measuring 9 μm by 14 μm; and the like.

There is no special limitation on a height of the main spacer or the sub spacer, but from the perspective of the trade-off between the occurrence of air bubbles caused by external impact in a low-temperature environment and the effects of absorbing a pressure load, the height of the sub spacer is preferably lower than the height of the main spacer by 0.2 μm to 0.7 μm. When the liquid crystal display panel is manufactured by the one drop fill technique, for example, by having such a height difference between the main spacer and the sub spacer, the occurrence of air bubbles can be suppressed even if the liquid crystal display panel is placed in a low-temperature environment, or a shock or a pressure load is applied to the liquid crystal display panel. That is because the height difference can reduce the difference in elastic characteristics between the sub spacer and the opposite substrate, which allows the sub spacer to deform so as to follow the deformation of the opposite substrate. This reduces the likelihood that a small gap or the like is created between the sub spacer and the opposite substrate, leading to the suppression of the air bubbles.

If the height difference between the main spacer and the sub spacer is too small, in the above-described situations such as when a pressure load is applied, the difference in elastic characteristics between the sub spacer and the opposite substrate becomes greater. This makes it difficult for the sub spacer to deform so as to follow the deformation of the opposite substrate. As a result, a small gap and the like become more likely to be created between the sub spacer and the opposite substrate, and air bubbles may therefore be generated. On the other hand, the excessive height difference between the main spacer and the sub spacer makes it difficult for the sub spacer to make contact with the opposite substrate when the pressure load is applied from the outside, and therefore, the effect of the spacer absorbing the pressure load is reduced.

The main spacer and the sub spacer may be formed separately, but it is more preferable to form them simultaneously for reducing the number of manufacturing processes and the manufacturing cost. The main spacer and the sub spacer can be formed simultaneously by employing the half-tone exposure, the gray-tone exposure, the double exposure, and the like, for example. Among them, the half-tone exposure and the gray-tone exposure are more preferable. When the half-tone exposure is employed, for example, the relative transmittance in a half-tone region is set to be about 10% to 30%.

In the present invention, the common electrode may have an alignment control structure that becomes an alignment center in a location that overlaps the transmissive display region when the substrate surface is viewed from the normal direction. The alignment control structure may be a hole formed in the common electrode. With use of such an alignment control structure, the orientation state of the liquid crystals can be controlled without sacrificing the aperture ratio of the pixel or the transmission contrast.

In one aspect of the liquid crystal display device according to the present invention, the columnar spacer may have a shape that is narrower on the side of the opposite substrate as compared with the side of the thin film transistor array substrate. The columnar spacer is formed by the exposure process as described above, for example, and the finished spacer may have a tapered shape at the edge of the end surface. Even with such a shape, a sufficient alignment control force for the liquid crystals can be provided in a manner similar to above.

In the liquid crystal display device of the present invention, it is preferable that the vertical alignment mode be employed for the liquid crystal layer. The vertical alignment mode is a display mode using negative type liquid crystals with negative dielectric anisotropy where liquid crystal molecules are aligned in the substantially normal direction to a substrate surface when a voltage below the threshold voltage is applied (when no voltage is applied, for example), and when a voltage equal to or greater than the threshold voltage is applied, the liquid crystal molecules shift to a substantially horizontal position to the substrate surface. The liquid crystal molecules with negative dielectric anisotropy have a greater dielectric constant in the minor axis direction as compared with that in the major axis direction. In the liquid crystal display device according to the present invention, by employing the vertical alignment mode, a high contrast ratio can be achieved.

The respective configurations described above may be suitably combined without departing from the scope of the present invention.

### Effects of the Invention

According to the liquid crystal display device of the present invention, by employing the single-domain structure with the columnar spacer disposed in the corner of the pixel, the transflective liquid crystal display device having high light transmittance and reflectance, an excellent visibility, and suitable display characteristics achieved by the sufficiently controlled liquid crystal orientation can be provided.

### BRIEF DESCRIPTION OF THE DRAWINGS

FIG. 1 is a plan view schematically showing a configuration of a liquid crystal display device according to Embodiment 1.

FIG. 2 is a schematic cross-sectional view along the line A-B in the liquid crystal display device shown in FIG. 1.

FIG. 3 is a plan view schematically showing an alignment control direction of liquid crystals in the liquid crystal display device shown in FIG. 1.

FIG. 4 is a plan view schematically showing a configuration of a liquid crystal display device according to Embodiment 2.

FIG. 5 is a schematic cross-sectional view along the line A-B in the liquid crystal display device shown in FIG. 4.

FIG. 6 is a plan view schematically showing a configuration of a liquid crystal display device according to Embodiment 3.

FIG. 7 is a schematic cross-sectional view along the line A-B in the liquid crystal display device shown in FIG. 6.

FIG. 8 is a plan view schematically showing a configuration of a liquid crystal display device according to Comparison Embodiment 1.

FIG. 9 is a schematic cross-sectional view along the line A-B in the liquid crystal display device shown in FIG. 8.

FIG. 10 is a graph showing a relationship between pixel resolutions and aperture ratios in Working Example 1 and Comparison Example 1.

FIG. 11 is a graph showing a relationship between pixel resolutions and response times in Working Example 1 and Comparison Example 2.

### DETAILED DESCRIPTION OF EMBODIMENTS

Embodiments are described below to further explain the present invention in detail with reference to figures. However, the present invention is not limited to these embodiments.

### Embodiment 1

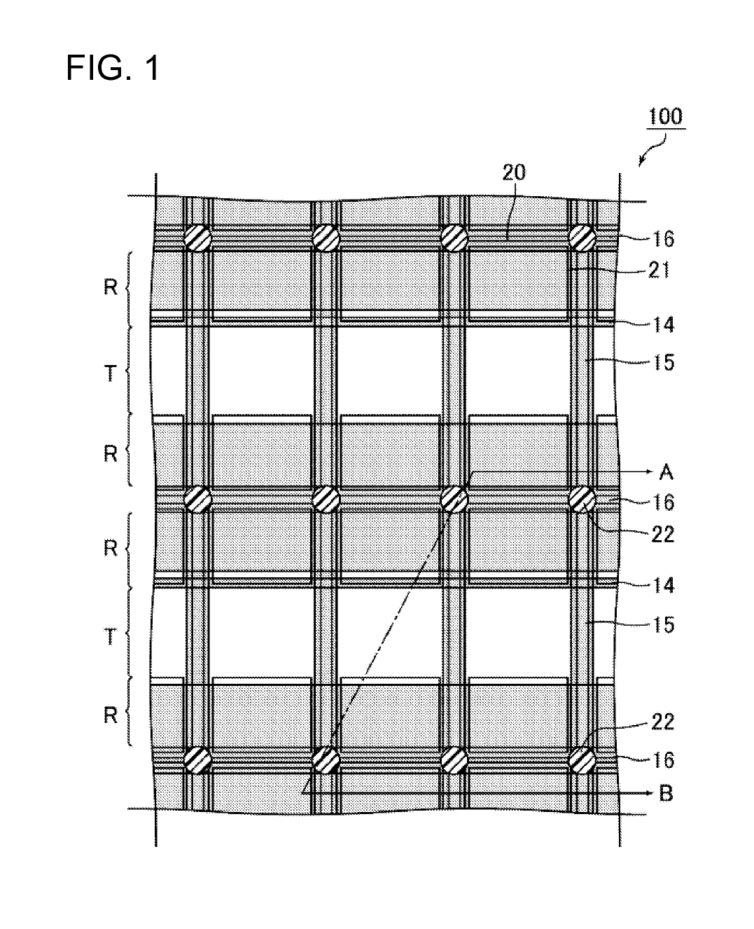

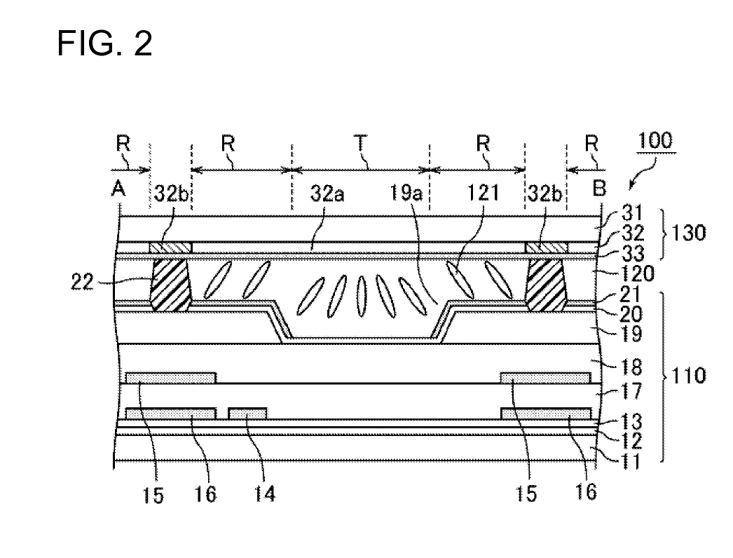

FIG. 1 is a plan view schematically showing a configuration of a liquid crystal display device according to Embodiment 1 of the present invention. FIG. 2 is a schematic cross-sectional view along the line A-B in the liquid crystal display device shown in FIG. 1.

In FIGS. 1 and 2, a liquid crystal display device 100 is a transflective liquid crystal display device 100 that includes a TFT array substrate 110, a liquid crystal layer 120, and an opposite substrate 130 disposed in this order. The liquid crystal display device 100 also includes reflective display regions R that perform a reflective display and transmissive display regions T that perform a transmissive display. When the substrate surface is viewed from the normal direction, the transmissive display regions T are disposed in center sections of respective pixels, and the reflective display regions R are disposed on both sides of the respective transmissive display regions T.

In the transmissive display region T, the TFT array substrate 110 includes a base coat film 12, a gate insulating film 13, an interlayer insulating film 17, a first resin film 18, a second resin film 19, and a pixel electrode 20 that are formed on a primary surface of a supporting substrate 11 made of an insulating substrate such as a glass substrate.

In the reflective display region R, the TFT array substrate 110 includes the base coat film 12 and the gate insulating film 13 formed on the primary surface of the supporting substrate 11, and on the gate insulating film 13, gate lines 14 and source lines 15 are arranged in a lattice pattern. Although not shown in the figure, TFTs are formed near the respective intersections of the gate lines 14 and the source lines 15. Between the respective adjacent gate lines 14, Cs wiring lines 16 are formed. The interlayer insulating film 17, the first resin film 18, the second resin film 19, the pixel electrode 20, and a reflective electrode 21 are formed so as to cover those wiring lines.

In the opposite substrate 130, a colored resin layer 32 that includes a CF layer 32a and a black matrix 32b, and a common electrode 33 are disposed in this order on a primary surface of a supporting substrate 31 made of an insulating substrate such as a glass substrate. The CF layer 32a has red (R), green (G), and blue (B) colors in the transmissive display region T as well as in the reflective display region R. The black matrix 32b is made of a light-shielding material, and is disposed for preventing colors from being mixed with each other in bordering regions of the respective colors. In this embodiment, the black matrix 32b is formed in a striped pattern so as to overlap the source lines 15 when the substrate surface is viewed from the normal direction. Light is blocked by the reflective electrodes 21 and the gate lines 14 at the boundaries of the transmissive display regions T and the reflective display regions R.

From the perspective of the display characteristics, it is preferable that the reflective display region R and the transmissive display region T have the same optical path length of light passing through the respective regions. Therefore, the liquid crystal display device 100 according to this embodiment employs the TFT multi-gap structure where a recess 19a is formed in the second resin film 19 disposed in the TFT array substrate 110 so that the thickness of the liquid crystal layer 120 in the reflective display region R becomes about half of the thickness of the liquid crystal layer 120 in the transmissive display region T.

It is more preferable that the thickness be exactly half, but it may also be about half as long as the respective optical path lengths of the light passing through the liquid crystal layer 120 in the reflective display region R and in the transmissive display region T are close enough to have no substantial effect on the display quality. Specifically, the thickness of the liquid crystal layer 120 in the reflective display region R is preferably 30 to 70% of the thickness of the liquid crystal layer 120 in the transmissive display region T.

In the liquid crystal display device 100 according to this embodiment, columnar spacers 22 protruding toward the liquid crystal layer 120 side are disposed at the corners of respective pixels as alignment control structures that regulate the orientation of liquid crystals. That is, the liquid crystal display device 100 according to this embodiment employs the single-domain structure. This allows for the improvement in the aperture ratio of the pixels, and high light transmittance in the transmissive display region T and high light reflectance in the reflective display region R can therefore be achieved.

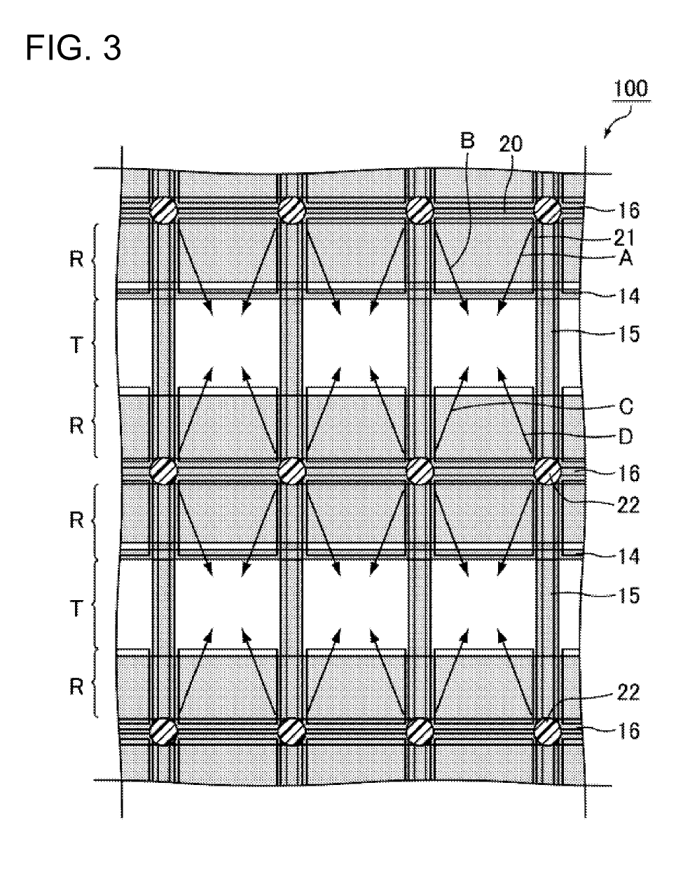

The columnar spacers 22 generate an alignment control force acting on the liquid crystals in the direction from the respective corners of the pixel toward the center section thereof. FIG. 3 is a plan view schematically showing the directions of the alignment control force acting on the liquid crystals in the respective pixels. The directions of the alignment control force acting on the liquid crystals are indicated with the arrows A to D in the figure. In FIG. 3, as shown with the arrows A to D, the alignment control force in the directions from the columnar spacers 22 disposed at the four corners of the pixel toward the center section of the pixel is generated, thereby restricting the orientation direction of the liquid crystals to these four directions. Although not shown in the figure, the alignment of the liquid crystals is also controlled by alignment films formed on respective surfaces of the TFT array substrate 110 and the opposite substrate 130 on the sides making contact with the liquid crystal layer 120.

The columnar spacers 22 are formed by photolithography using a photosensitive acrylic resin, for example. The columnar spacers 22 are formed to a prescribed height so as to make contact with the opposite substrate 130, and therefore maintain a gap between the TFT array substrate 110 and the opposite substrate 130, i.e., the cell gap, at a desired thickness. Therefore, the columnar spacers 22 according to this embodiment serve as main spacers for maintaining the cell gap in the liquid crystal display device.

There is no special limitation on a shape of the columnar spacers 22 as long as it is a columnar shape such as a circular column, a rectangular column, a cone, and a pyramid.

The liquid crystal display device 100 according to this embodiment employs the multi-gap structure as described above, and therefore, as shown in FIG. 2, liquid crystal molecules 121 are oriented along the directions from the reflective display region R toward the transmissive display region T. By adding the above-mentioned alignment control force generated by the columnar spacers 22 to such an orientation state, a strong alignment control force from all directions is generated in the respective pixels, and therefore, the suitable and stable orientation state of the liquid crystal molecules 121 can be obtained. This allows for wider viewing angle characteristics and improved response time, resulting in a suitable display quality.

According to the liquid crystal display device 100 of this embodiment, because the strong alignment control force from all directions can be obtained in the respective pixels, it is not necessary to dispose the reflective display region R so as to surround the transmissive display region T, and therefore, the reflective display region R can be disposed on both sides of the transmissive display region T (top and bottom, or left and right). This allows the reflective display region R to be enlarged without sacrificing the transmissive display region T. Also, even when the domain is enlarged, a response time similar to that of a liquid crystal display device with the multi-domain structure can be ensured.

By disposing the transmissive display region T and the reflective display region R in a manner described above, a slope region that exists at a boundary of the transmissive display region T and the reflective display region R can be reduced. In the slope region where a contrast ratio between the transmissive display region T and the reflective display region R becomes lower, it is necessary to form a light-shielding section so as to cover this region. In this embodiment, however, because the slope region can be reduced, the light-shielding section can also be reduced, resulting in the further increase in the aperture ratio of the pixel.

In the liquid crystal display device 100 according to this embodiment, because the strong alignment control force can be achieved as described above, it is no longer necessary to form alignment control structures on the side of the opposite substrate 130 for controlling the orientation of liquid crystals. This leads to a simpler manufacturing process and a lower manufacturing cost.

When the columnar spacers 22 are formed by photolithography using a photosensitive resin as described below, the finished spacer may become narrower on the side of the opposite substrate 130 as compared with the side of the TFT array substrate 110. Even if the columnar spacers 22 have such a shape, the alignment control force for the liquid crystals is still provided with the alignment vectors toward the center of the domain in a manner similar to above. These alignment vectors coincide with the vectors from the edges of the pixel electrode 20 toward the center of the domain without conflict. Further, these alignment vectors also coincide with the alignment vectors generated by the multi-gap structure in the direction toward the transmissive display region T from the reflective display regions R. This ensures the sufficient alignment control force for the liquid crystals.

In this embodiment, the columnar spacers 22 are formed on the TFT array substrate 110 side. When the columnar spacers 22 are formed at the four corners of the respective pixels on the opposite substrate 130 side, the columnar spacers 22 generate alignment vectors along the directions opposite to the above-mentioned alignment vectors indicated with the arrows A to D. These alignment vectors therefore conflict with the alignment vectors from the edges of the pixel electrode 20, and as a result, unwanted central axes of alignment appear in the pixel in a random manner, thereby lowering the display quality.

It is technically possible to make the alignment vectors for the liquid crystals generated by the columnar spacers 22 coincide with the alignment vectors from the edges of the pixel electrode 20 even when the columnar spacers 22 are formed on the opposite substrate 130 side. However, in order to do so, the columnar spacers 22 would need to be formed in the center sections of the respective domains, which are the center sections of the respective transmissive display regions T, and this would lower the aperture ratio of the transmissive display regions T. Also, it would create a need to form light-shielding portions around the columnar spacers 22 because the disarrayed liquid crystal orientation tends to occur around the columnar spacers 22, possibly causing light leakage. This would lower the aperture ratio of the transmissive display regions T.

Thus, in the present invention, the columnar spacers 22 are formed on the TFT array substrate 110 side.

The liquid crystal display device 100 having the above-mentioned configuration is manufactured through the following processes, for example. First, the TFT array substrate 110 will be explained. On the supporting substrate 11 made of a glass substrate, the base coat film 12 and the gate insulating film 13 were formed so as to cover the primary surface thereof. Next, the gate lines 14 and the Cs wiring lines 16 were formed in a desired shape, and the interlayer insulating film 17 was formed so as to cover these wiring lines. Next, on the interlayer insulating film 17, the source lines 15 were formed. This way, TFTs (not shown) in a desired shape were formed. Thereafter, the first resin film 18 and the second resin film 19 were formed so as to cover the source lines 15.

The first resin film 18 and the second resin film 19 were formed by using a two-layer mask. That is, the first resin film 18 was formed with the spinning speed of 900 rpm to 1000 rpm so that the film thickness becomes 2.5 μm to 3.0 μm. Thereafter, using a mask that has been prepared so as to form the recess 19a in the transmissive display region, the second resin film 19 was formed with the spinning speed of 1300 rpm to 1400 rpm so that the film thickness becomes 1.5 μm to 2.0 μm. As a result, the recess 19a is formed in the transmissive display region when the substrate surface is viewed from the normal direction.

The recess 19a can also be formed by applying a photosensitive resin so as to cover the second resin film 19, and thereafter conducting the half-tone exposure. In this case, the exposure condition can be set to 2300 msec to 2800 msec, for example.

Next, on the second resin film 19 having the recess 19a, the pixel electrode 20 made of indium tin oxide (ITO), and the reflective electrode 21 made of a laminated body including indium zinc oxide (IZO), aluminum, and molybdenum were formed, and were thereafter patterned into desired shapes, respectively.

Next, the columnar spacers 22 were formed by applying a photosensitive transparent acrylic resin and conducting photolithography. The columnar spacers 22 were disposed in the positions that correspond to the four corners of the respective pixels and that overlap the black matrix 32b when the substrate surface is viewed from the normal direction after the TFT array substrate 110 and the opposite substrate 130 are bonded together. The columnar spacers 22 were formed in the reflective display regions R by photolithography using a transparent photosensitive resin. Further, an alignment film was formed by applying a polyimide resin so as to cover the entire surface of the substrate.

Further, an alignment film (not shown) was formed by applying a polyimide resin so as to cover the entire surface of the substrate. The TFT array substrate 110 was obtained in this manner.

On the other hand, in order to obtain the opposite substrate 130, first, the colored resin layer 32 including the CF layer 32a and the black matrix 32b was formed to the film thickness of 2.0 μm and 2.8 μm on a primary surface of the supporting substrate 31 made of a glass substrate. The CF layer 32a was constituted of colored layers of R (red), G (green), and B (blue). The black matrix 32b was formed in boundary regions of the respective colors.

The common electrode 33 having a film thickness of 800 Å to 1500 Å was formed so as to cover the obtained colored resin layer 32. Thereafter, an alignment film (not shown) was formed by applying a polyimide resin so as to cover the entire surface of the substrate. The opposite substrate 130 was obtained in this manner.

When the substrate surface is viewed from the normal direction after the TFT array substrate 110 and the opposite substrate 130 are bonded together, the columnar spacers 22 formed in the TFT array substrate 110 are disposed in the positions that overlap the black matrix 32b, that is, in the boundary regions of the colored layers. Therefore, an overcoat film may further be formed between the colored resin layer 32 and the common electrode 33.

The TFT array substrate 110 and the opposite substrate 130 prepared in a manner described above were bonded together with a sealant (not shown) such that the alignment films face each other. Thereafter, by injecting liquid crystals between the two substrates, the liquid crystal layer 120 was formed. The liquid crystal layer 120 became 1.5 μm to 1.8 μm thick in the reflective display region R, and became 3.0 μm to 3.6 μm thick in the transmissive display region T. That is, the thickness in the reflective display region R was about half of the thickness in the transmissive display region T.

Because the liquid crystal display device 100 according to this embodiment has a very strong alignment control force provided by the columnar spacers 22 disposed at the corners of the respective pixels, alignment control structures for the liquid crystals are not formed on the opposite substrate 130 side. If necessary, however, alignment control structures may be formed on the opposite substrate 130 side. The alignment control structures include protrusions such as rivets, holes or slits that are formed in the common electrode 33, and the like.

An example of also forming the alignment control structures on the opposite substrate 130 side will be explained below.

### Embodiment 2

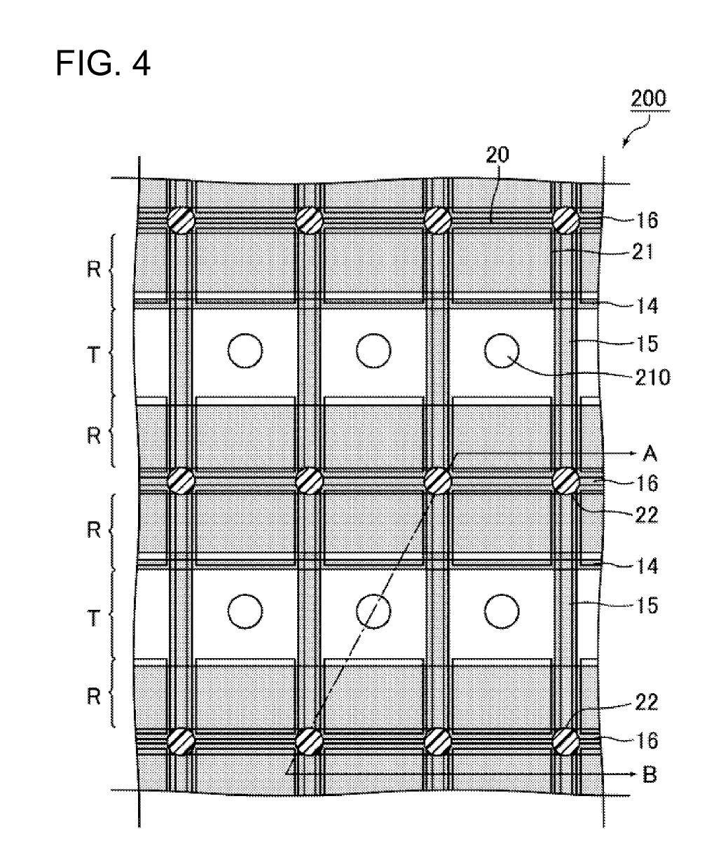

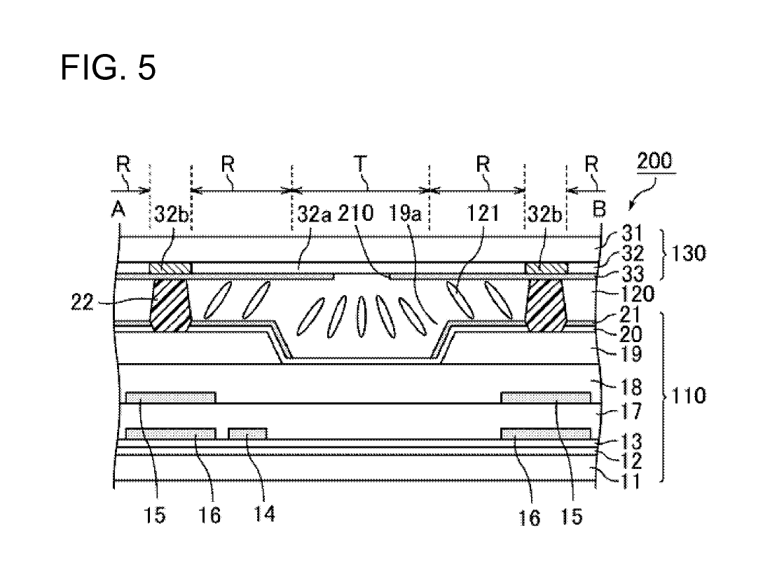

In this embodiment, an example of forming alignment control structures on the opposite substrate 130 side in addition to the configuration described in Embodiment 1 above will be explained with reference to FIGS. 4 and 5. FIG. 4 is a plan view that schematically shows a configuration of a liquid crystal display device according to this embodiment. FIG. 5 is a schematic cross-sectional view along the line A-B in the liquid crystal display device shown in FIG. 4. The same reference characters are given to members and parts that have the same configurations as those in Embodiment 1 above, and the explanations thereof will be omitted.

In a liquid crystal display device 200 shown in FIGS. 4 and 5, holes 210 are formed in the common electrode 33. The holes 210 are disposed in the centers of the respective transmissive display regions T, i.e., the centers of the respective pixels, when the substrate surface is viewed from the normal direction. In such a configuration, the alignment control force that makes the liquid crystal molecules 121 tilt in the direction toward the hole 210 from the peripheral region of the transmissive display region T is generated, making the liquid crystal orientation even more stable.

Therefore, the holes 210 formed in the common electrode 33 in this embodiment can be regarded as an alignment control structure that becomes the alignment center of the liquid crystals.

### Embodiment 3

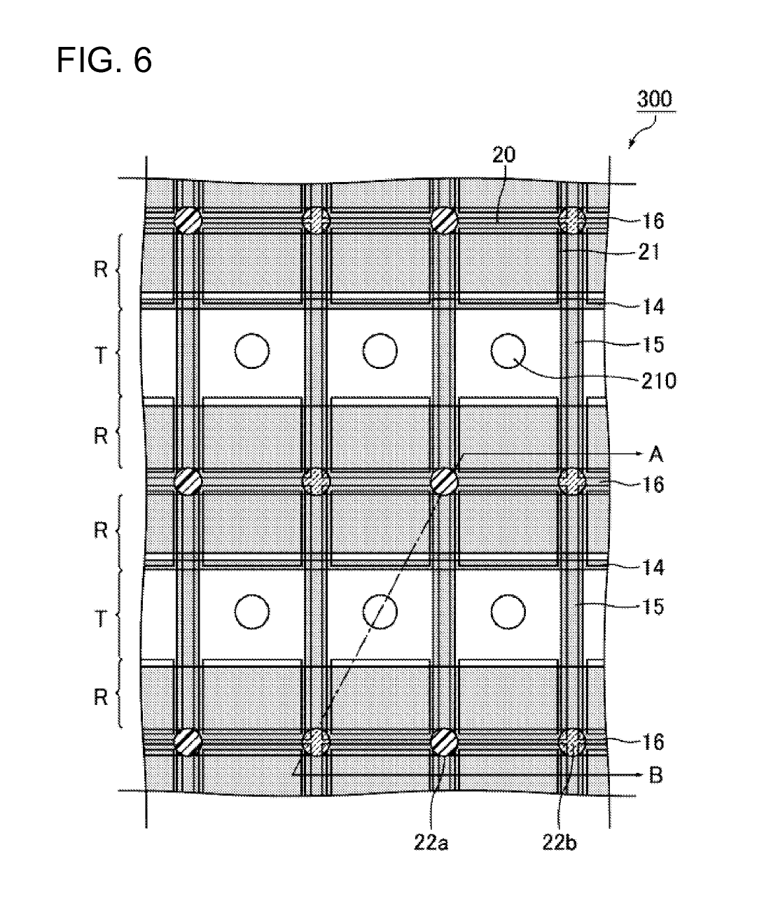

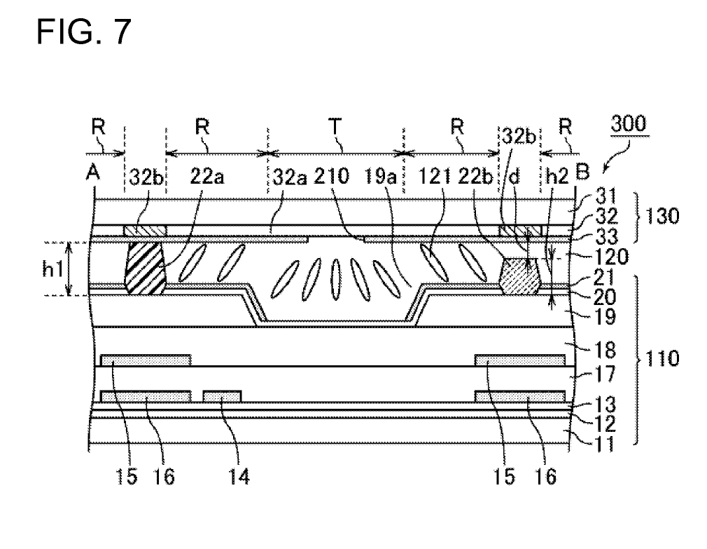

In this embodiment, an example of a liquid crystal display device that further includes both main spacers and sub spacers as the columnar spacers in addition to the configuration described in Embodiment 2 above will be explained with reference to FIGS. 6 and 7. FIG. 6 is a plan view schematically showing a configuration of a liquid crystal display device according to this embodiment. FIG. 7 is a schematic cross-sectional view along the line A-B in the liquid crystal display device shown in FIG. 6. The same reference characters are given to members and parts that have the same configurations as those in Embodiments 1 and 2 above, and the explanations thereof will be omitted.

In addition to the configuration of the liquid crystal display device 200 of Embodiment 2 above, a liquid crystal display device 300 shown in FIGS. 6 and 7 has a configuration where the columnar spacers include main spacers 22a that are in contact with the opposite substrate 130 and sub spacers 22b that are not in contact with the opposite substrate 130.

The main spacers 22a are rectangular columns measuring 12 μm by 12 μm, respectively. The sub spacers 22b are circular columns of 12 μm in diameter, respectively. As shown in FIG. 7, a height h2 of the sub spacer 22b is lower than a height h1 of the main spacer 22a, and between the sub spacer 22b and the opposite substrate 130, a gap “d” is formed. It is preferable that the height h2 of the sub spacer 22b be lower than the height h1 of the main spacer 22a by 0.2 μm to 0.7 μm.

In the liquid crystal display device 300 having such a configuration, the main spacer 22a and the opposite substrate 130 are in contact in a normal state, and when a pressure load is applied and the opposite substrate 130 is bent, the sub spacer 22b makes contact with the opposite substrate 130, thereby absorbing the pressure load. This allows the liquid crystal display device 300 to have an excellent pressure load tolerance. Also, in contrast to the case where the columnar spacers include main spacers only, the occurrence of air bubbles can be suppressed in a manner described earlier.

In this embodiment, the main spacers 22a and the sub spacers 22b may be formed separately, but taking into account the manufacturing efficiency, it is preferable to form both spacers simultaneously in the same process. The main spacers 22a and the sub spacers 22b can be formed simultaneously by applying a photosensitive material on the second resin film 19, and conducting an exposure process for this photosensitive material by using a half-tone mask where the relative transmittance of the half-tone region thereof is set to be about 10% to 30%, for example. Besides the exposure process using the half-tone mask, an exposure process using a gray tone mask can also be employed.

The explanation above has described an example of adding the sub spacers 22b to the configuration of the liquid crystal display device 200 of Embodiment 2. However, this embodiment is not limited to such, and the sub spacers 22b can also be added to the configuration of the liquid crystal display device 100 of Embodiment 1.

Not only a height, but also a shape of the sub spacers 22b may be different from that of the main spacers 22a.

Although a configuration where the columnar spacers 22 are formed near the intersections of the source lines 15 and the Cs wiring lines 16 has been described as an example in the respective embodiments above, the present invention is not limited to such. When the pixels are divided by the gate lines 14 and the source lines 15, the columnar spacers may be formed near the intersections of the gate lines 14 and the source lines 15. Even with such a configuration, the effects similar to above can be achieved.

In the present invention, the Polymer Sustained Alignment (PSA) technology can also be employed as a technique for controlling the liquid crystal alignment. In PSA, polymers having a memory of pre-tilt angle of liquid crystals are disposed on a substrate. The polymers can be obtained by mixing polymerizable components, such as monomers, oligomers, or the like, in liquid crystals, and by polymerizing the polymerizable components while applying a voltage to the liquid crystals so as to tilt the liquid crystal molecules during the polymerization.

### Comparison Embodiment 1

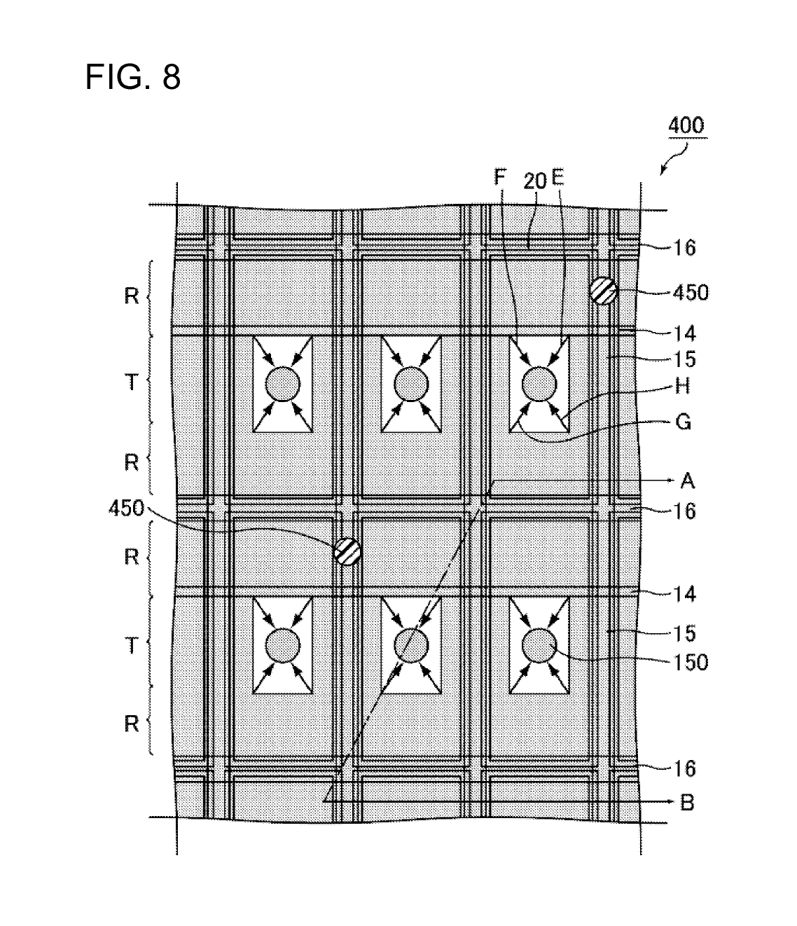

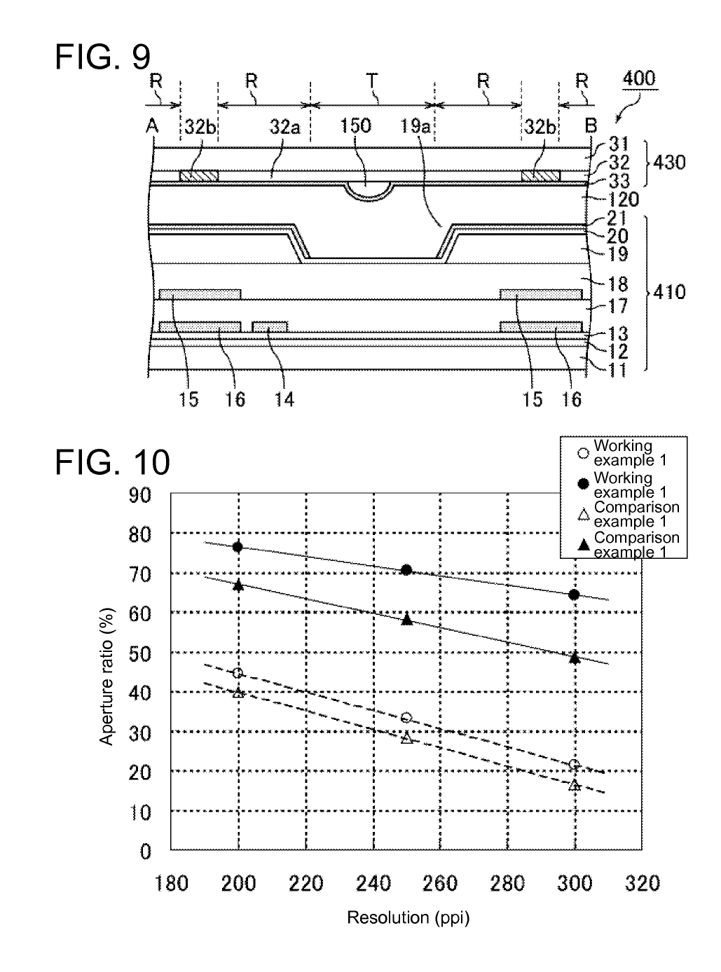

A configuration of a liquid crystal display device according to Comparison Embodiment 1 will be explained below with reference to FIGS. 8 and 9. FIG. 8 is a plan view schematically showing a configuration of a liquid crystal display device according to this comparison embodiment. FIG. 9 is a schematic cross-sectional view along the line A-B in the liquid crystal display device shown in FIG. 8. The same reference characters are given to members and parts that have the same configuration as those in Embodiment 1 above, and the explanations thereof will be omitted.

A liquid crystal display device 400 shown in FIGS. 8 and 9 is a liquid crystal display device with the single-domain structure where the transmissive display region T is disposed in the center section of a pixel. In a TFT array substrate 410, columnar spacers are not disposed at the corners of the pixels when the substrate surface is viewed from the normal direction, and main spacers 450 for maintaining a gap between the TFT array substrate 410 and an opposite substrate 430 are appropriately formed in some pixels, instead of all pixels.

The opposite substrate 430 is configured to have a protrusion 150 covered by a common electrode 43 on the colored resin layer 32 in the transmissive display region T. The orientation of the liquid crystal 120 is regulated by this protrusion 150 in the directions indicated by the arrows E to H.

The liquid crystal display device 100 according to Embodiment 1 above and the liquid crystal display device 400 according to Comparison Embodiment 1 above will be explained below with specific examples.

### Working Examples 1

Measurements were conducted to obtain a relationship between the pixel resolution (ppi; pixels per inch) and the aperture ratio (%) with respect to the liquid crystal display device 100 of Embodiment 1 above. The pixel resolution was set to 200 ppi, 250 ppi, and 300 ppi, and with respect to the liquid crystal display devices 100 having the respective resolutions, the aperture ratio (transmissive) of the transmissive region only relative to the entire pixel, and the aperture ratio (total) of both the transmissive region and the reflective region were obtained, respectively. The obtained measurement results are shown in Table 1 below.

The response time (ms) was also measured with respect to the liquid crystal display devices 100 respectively having the resolutions described above. In conducting the measurement, the response time has been defined as a length of time required to reach from 10% to 90% of a target luminance when the start luminance was 0/255 gradation, and the target luminance is 64/255 gradation. The obtained measurement results are shown in Table 2 below.

### Comparison Examples 1

For liquid crystal display devices 400 with a conventional multi-domain structure, the aperture ratio was measured with respect to various pixel resolutions in a manner similar to Working Examples 1 above. The obtained measurement results are shown in Table 1 below. The liquid crystal display devices with the conventional multi-domain structure were not provided with the columnar spacers 22 disposed at the four corners of the respective pixels, and the respective pixels are divided into domains, which are the transmissive display region T in the center section and the reflective display regions R on both sides of the transmissive display region T (with slits formed therebetween). Also, alignment control structures are disposed in this liquid crystal display device.

### Comparison Examples 2

For liquid crystal display devices with a conventional single-domain structure, the response time (ms) was measured with respect to various pixel resolutions in a manner similar to Working Examples 1 above. The liquid crystal display devices with the conventional single-domain structure are liquid crystal display devices that are similar to the liquid crystal display device 100 of Embodiment 1, but the columnar spacers 22 are not provided at the four corners of the respective pixels, and the reflective display regions R are disposed in the center sections of the respective pixels. The obtained measurement results are shown in Table 2 below.

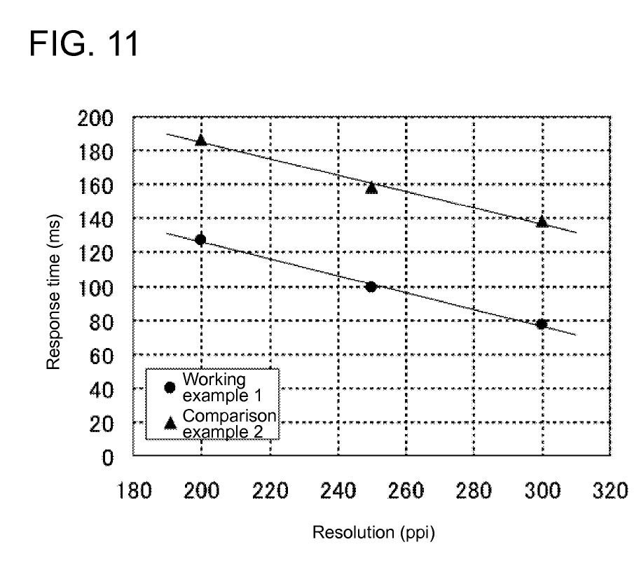

FIGS. 10 and 11 show graphs illustrating the measurement results shown in Tables 1 and 2 below. FIG. 10 is a graph showing a relationship between the pixel resolution and the aperture ratio with respect to Working Examples 1 and Comparison Examples 1. FIG. 11 is a graph showing a relationship between the pixel resolution and the response time with respect to Working Examples 1 and Comparison Examples 2.

In FIG. 10, white dots and black dots indicate the measurement results of Working Examples 1. The aperture ratios of the transmissive region only relative to the entire pixel are plotted with the white dots, and the aperture ratios of both the transmissive region and the reflective region relative to the entire pixel are plotted with the black dots, respectively. White triangles and black triangles indicate the measurement results of Comparison Examples 1. The aperture ratios of the transmissive region only relative to the entire pixel, and the aperture ratios of both the transmissive region and the reflective region relative to the entire pixel are plotted with the white triangles and the black triangles, respectively. In FIG. 11, black dots indicate the measurement results of Working Examples 1, and black triangles indicate the measurement results of Comparison Examples 2, respectively.

TABLE 1

| | Aperture ratio (%) | |
|---|---|---|
| | Working | Comparison |
| Resolution | Examples 1 | Examples 1 |

| (ppi) | Transmissive | Total | Transmissive | Total |
|---|---|---|---|---|
| 200 | 44.5 | 76.3 | 39.9 | 67.0 |
| 250 | 33.1 | 70.5 | 28.2 | 58.2 |
| 300 | 21.5 | 64.1 | 16.6 | 48.5 |

TABLE 2

| | |
|---|---|
| Resolution | Response time (ms) |

| (ppi) | Working Examples 1 | Comparison Examples 2 |
|---|---|---|
| 200 | 127 | 186 |
| 250 | 99 | 158 |
| 300 | 77 | 138 |

As shown in Table 1 above and FIG. 10, it became apparent that the higher pixel aperture ratio can be obtained in the liquid crystal display device 100 according to Embodiment 1 as compared with the liquid crystal display device 400 with the multi-domain structure according to Comparison Embodiment 1. It also became apparent that, in the liquid crystal display device 100 according to Embodiment 1, it is possible to significantly suppress the reduction in the aperture ratio even when the pixel resolution is increased to 300 ppi as compared with the liquid crystal display device 400 with the multi-domain structure. As a result, it became apparent that both the higher pixel aperture ratio and the higher pixel resolution can be achieved in the liquid crystal display device 100 according to Embodiment 1.

As shown in Table 2 above and FIG. 11, it became apparent that the liquid crystal display device 100 according to Embodiment 1 has a shorter response time than the liquid crystal display device with the single-domain structure according to Comparison Example 2. It also became apparent that, in the liquid crystal display device 100 according to Embodiment 1, as the pixel resolution becomes higher, the response time becomes shorter because of the domain size becoming smaller.

As described above, the liquid crystal display device according to the present invention includes columnar spacers disposed at the four corners of the respective pixels. This provides the improved control on the liquid crystal orientation, thereby achieving suitable display characteristics. Additionally, this allows the liquid crystal display device to have the shorter response time while maintaining the high aperture ratio of the pixel.

The respective configurations described in the embodiments above may be suitably combined without departing from the scope of the present invention.

It should be noted that the present application claims priority to Japanese Patent Application No. 2009-206177 filed in Japan on Sep. 7, 2009 under the Paris Convention and provisions of national law in a designated State. The entire contents of which are hereby incorporated by reference.

### DESCRIPTION OF REFERENCE CHARACTERS

11, 31 supporting substrate
12 base coat film
13 gate insulating film
14 gate line
15 source line
16 Cs wiring line
17 interlayer insulating film
18 first resin film
19 second resin film
19a recess
20 pixel electrode
21 reflective electrode
22 columnar spacer
22a, 450 main spacer
22b sub spacer
32 colored resin layer
32a CF layer
32b black matrix
33, 43 common electrode
100, 200, 300, 400 liquid crystal display device
110, 410 TFT array substrate
120 liquid crystal layer
121 liquid crystal molecule
130, 430 opposite substrate
150 protrusion
210 hole
d gap
h1 height of main spacer
h2 height of sub spacer
R reflective display region
T transmissive display region

1. A liquid crystal display device, comprising:
a liquid crystal layer sandwiched between a thin film transistor array substrate and an opposite substrate; and
a plurality of pixels respectively having a reflective display region that performs a reflective display and a transmissive display region that performs a transmissive display,
wherein said transmissive display region is disposed in a center section of each pixel when a substrate surface is viewed from a normal direction,
wherein said thin film transistor array substrate includes an insulating film formed on a primary surface of a supporting substrate on a side facing the liquid crystal layer; and a columnar spacer protruding toward the liquid crystal layer side at a corner of each pixel, the insulating film having a recess formed in said transmissive display region, and
wherein said opposite substrate has a common electrode on a primary surface thereof on a side facing the liquid crystal layer.

2. The liquid crystal display device according to claim 1, wherein the columnar spacers includes a main spacer and a sub spacer, and the main spacer is in contact with the opposite substrate, and the sub spacer is not in contact with said opposite substrate.

3. The liquid crystal display device according to claim 1, wherein the common electrode includes an alignment control structure that becomes an alignment center in a location that overlaps the transmissive display region when the substrate surface is viewed from the normal direction.

4. The liquid crystal display device according to claim 3, wherein the alignment control structure is a hole formed in the common electrode.

5. The liquid crystal display device according to claim 1, wherein the columnar spacer is narrower on the side of the opposite substrate as compared with the side of the thin film transistor array substrate.

6. The liquid crystal display device according to claim 1, wherein the liquid crystal layer is of vertical alignment mode.
